(19) United States
(12) Patent Application Publication
(10) Pub. No.: US 2007/0026852 A1
(43) Pub. Date: Feb. 1, 2007

(54) Multimedia telephone system

(75) Inventors: James D. Logan, Candia, NH (US); Charles G. Call, West Yarmouth, MA (US)

Correspondence Address: CHARLES G. CALL, 68 HORSE POND ROAD, WEST YARMOUTH, MA, 02673-2516, US

(73) Assignee: James D. Logan, Candia, NH (US)

(21) Appl. No.: 11/542,379

(22) Filed: Oct. 3, 2006

Related U.S. Application Data
(63) Continuation-in-part of application No. 10/984,018, filed on Nov. 8, 2004.
Application No. 10/984,018 is a continuation-in-part of application No. 10/160,710, filed on May 31, 2002, now Pat. No. 6,816,577.
Application No. 10/984,018 is a continuation-in-part of application No. 10/680,643, filed on Oct. 7, 2003, now Pat. No. 6,996,402.
Application No. 10/680,643 is a continuation-in-part of application No. 09/651,542, filed on Aug. 29, 2000, now Pat. No. 6,631,271.
Application No. 10/680,643 is a continuation-in-part of application No. 10/160,711, filed on May 31, 2002, now Pat. No. 6,788,766.
(63) Continuation-in-part of application No. 09/782,546, filed on Feb. 13, 2001, now abandoned.
Application No. 09/782,546 is a division of application No. 08/724,813, filed on Oct. 2, 1996, now Pat. No. 6,199,076.
(60) Provisional application No. 60/295,469, filed on Jun. 1, 2001.
(60) Provisional application No. 60/295,404, filed on Jun. 2, 2001.

(51) Int. Cl. H04Q 7/20

(52) U.S. Cl. 455/422.1

(57) ABSTRACT

A multi-media telephone system capable of presenting multi-media content to users defined by structured script files incorporating markup tags, such as HTML, XML, SMIL or VoiceXML tags. The script files form “homepage” presentations displayed on the telephone stationset. The script files may be transmitted from called parties to calling parties at the time a telephone connection is first established, or transmitted at the request of either party thereafter, and are executed by a processor in the receiving stationset (such as a cellular telephone), providing both visual displays and audio output in an interactive interface which can be used to provide additional information or services from a menu of displayed or spoken option prompts.

### CROSS REFERENCE TO RELATED APPLICATIONS

This application is a continuation in part of U.S. application Ser. No. 09/782,546 filed on Feb. 13, 2001 by James D. Logan, Daniel Goessling and Charles G. Call entitled “Broadcast Program and Advertising Distribution System.”

The above-identified application Ser. No. 09/782,546 was a division of U.S. patent application Ser. No. 08/724,813 filed on Oct. 2, 1996 which issued as U.S. Pat. No. 6,199,076 on Mar. 6, 2001, the disclosure of which is also found in the related U.S. Pat. Nos. 5,732,216 entitled “Audio message exchange system” and 5,721,827 entitled “System for electrically distributing personalized Information” issued on Feb. 24, 1998.

This application is also a continuation in part of U.S. patent application Ser. No. 10/984,018 filed on Nov. 8, 2004 by James D. Logan and Caren Thomburgh-Logan entitled “Communication and control system using a network of location aware devices for message storage and transmission operating under rule-based control” published as U.S. Patent Application Publication No. 2005/0153729 A1 on Jul. 14, 2005.

The above-identified application Ser. No. 10/984,018 was a continuation in part of, and claims the benefit of the filing date of co-pending U.S. patent application Ser. No. 10/160,710 filed 5/31/2002 which issued as U.S. Pat. No. 6,816,577 on Nov. 9, 2004, and which claimed the benefit of the filing date of Provisional U.S. patent application Ser. No. 60/295,469 filed on Jun. 1, 2001. The above identified application Ser. No. 10/984,018 was also a continuation in part of, and claims the benefit of the filing date of co-pending U.S. patent application Ser. No. 10/680,643 filed on Oct. 7, 2003 which issued as U.S. Pat. No. 6,996,402 on Feb. 7, 2006 and which is a continuation in part of U.S. patent application Ser. No. 09/651,542 filed Aug. 29, 2000 issued as U.S. Pat. No. 6,631,271 on Oct. 7, 2003 and of U.S. patent application Ser. No. 10/160,711 which was filed on May 31, 2002 and issued as U.S. Pat. No. 6,788,766 on Sep. 7, 2004, and which claimed the benefit of the filing date of Provisional U.S. patent application Ser. No. 60/295,404 filed on Jun. 2, 2001.

This application claims the benefit of the filing date of each of the above-noted applications, and incorporates the disclosures of each of the foregoing patents and applications herein by reference.

### FIELD OF THE INVENTION

This invention relates to interactive multi-media telephone communications systems.

### BACKGROUND OF THE INVENTION

Today's consumers of media multitask in many ways, whether by reading while watching TV, playing video games while listening to music, or watching TV while exchanging IM messages. A common form of multitasking is “backgrounding;” that is, surfing the Internet on a PC while on the phone. This form of multitasking works quite well as a person's visual sense can be utilized while at the same time the person is engaged in the often passive task of listening.

Users of mobile phones, however, don't necessarily have opportunities to multitask in these usual ways when they are “out and about” and talking on their cell phones as other forms of media (reading material, Internet, video games, etc.) are typically not readily accessible when in the act of traveling.

Juxtaposed with this need to multitask is an ever-growing need by businesses to continually present their brand and a positive image to consumers. In addition, with the immense amount of information available on the Internet, the need to continually give consumers pertinent information that is relevant to a time and place is ever more important.

By the same token, consumers have a similar need to individualize their public persona and present an image they feel is appropriate. This is best exemplified by the billions of dollars spent worldwide in the purchase of cell phone ring tones—an acoustical accessory that is as much fashion statement as it is functional.

In the case of consumers and businesses, the phone pathway carries minimal metadata about the calling parties. Caller ID is the only data that the calling parties see and this is not user controlled in any way. This is in contrast to email or instant messaging where users can create their own screen names and email addresses, compose messages in any style of graphic they want, and send audio-visual messages as well.

Headsets, such as the wireless Bluetooth headsets now in common use, allow cell phone users to view the phone's screen while talking and use their hands to engage in other activities since it headset users don't need to hold the phone to their ears.

Today cell phones already have multi-media capabilities (that is, they provide both audio and video functions). Newer cell phones can take and send pictures and text messages. And they can access web pages and let users play screen-based games. Full motion video and video conferencing capabilities can be foreseen in the near future.

What is lacking, however, is a means to coordinate the presentation of screen graphics with a phone call. Even video-calls, although they involve simultaneous images and audio, are really just about seeing a face, not communicating information.

### SUMMARY OF THE INVENTION

The present invention may be implemented using a multi-media telephone stationset, such as a wired telephone, a portable handset, a cellular phone, a VoIP phone, or PDA or the like with communications capabilities. The stationset includes a display screen in addition to a microphone, speaker or earpiece, keypad, and one or processors. The stationset is programmed to receive and display “homepage” information to its operator when a telephone connection is first initiated, wherein the displayed “homepage” information describes the person or entity with whom the connection has been established, or services which that person or entity provides. The visual information supplements the conventional voice conversation channel established by the telephone connection and is typically implemented using a digital data communications channel may be the same as or operate in parallel with the channel carrying the voice conversation. The system can be used to improve the efficiency of call handling tasks, such as coping with phone directories and voice mail menus, or communicating information in the form of pictures and/or text which can be used to inform or entertain the telephone user.

In a preferred embodiment of the invention, the cellular phone's display screen is actively controlled by either party during a phone call and allows cellular phone users to multitask while on the phone, provides for automatic and user-controlled exchanges of text and graphic information during a telephone call, and can be used to enable both parties to present visual images including text displays to the other party during a phone conversation in new ways.

In its preferred form, the invention forms a telephone system that consists of a plurality of telephone stationsets interconnected with one another via a telecommunications network. Each of the telephone stationsets includes:
a speaker or earpiece for delivering audible sound to a human operator who operates the stationset;
a microphone for accepting spoken information from the operator;
a display screen for presenting visual information to the operator;
a keypad for accepting keypress commands from the operator;
a communications subsystem for establishing a telephone connection via the telecommunications network with a called person or entity at a remote location to whom a telephone number is assigned; and
one or more processors which execute a script file transmitted from the remote location via the telephone connection to perform a plurality of functions in a sequence.

The functions specified by the script file that are preferably performed by the stationset processor(s) include delivering audible sounds to the operator which are specified by the script file; concurrently displaying visual information specified by the script file to the operator which may include a displayed list of optional functions executable by said processor that may be selectively executed in response to spoken or keypressed selection commands from the operator.

Typically, the script file specifies a “homepage” display and is automatically transmitted from said remote location to the stationset when the telephone connection to a called party is first established. The calling party may also transmit a homepage via the established telephone connection for display and execution by the remote stationset.

The audio signals delivered to the stationset speaker or earpiece includes the normal telephone voice signals produced by a human speaker at said remote location during a telephone conversation with the operator. In addition, the audio signals may include speech produced by a text to speech conversion process from one or more text character strings included in the script file. In addition, the audio content may a reproduced separate audio file which resides in a media data object that is external to but identified in the script file.

The visual information delivered to the stationset display screen may be produced by rendering one or more natural language text strings contained in said script file or by reproducing the content of one or more separate image or video files which reside in media data objects which are external to but identified by said script file.

The script file which is transmitted to stationset via the telephone connection preferably takes the form of a file of text characters including imbedded markup tags that are recognized and interpreted by one or more stationset processors to identify and perform one or more functions. All or part of the script file may be advantageously expressed in one or more standard forms, including the HyperText Markup Language (HTML), the Extensible Markup Language (XML), the Synchronized Multimedia Integration Language (SMIL), the Voice Extensible Markup Language (VoiceXML), or a combination of these.

These and other objects, features and advantages of the invention may be better understood by considering the following detailed description.

### BRIEF DESCRIPTION OF THE DRAWINGS

In the detailed description which follows, frequent reference will be made to the attached drawings, in which:

FIG. 1 is a block diagram illustrating the principal components of the cellular telephone that are used to implement the present invention; and

FIG. 2 illustrates the exterior of a cellular telephone handset that includes a keypad and display which enables the user to view and interact with a “homepage” display received from a remote party.

### DETAILED DESCRIPTION

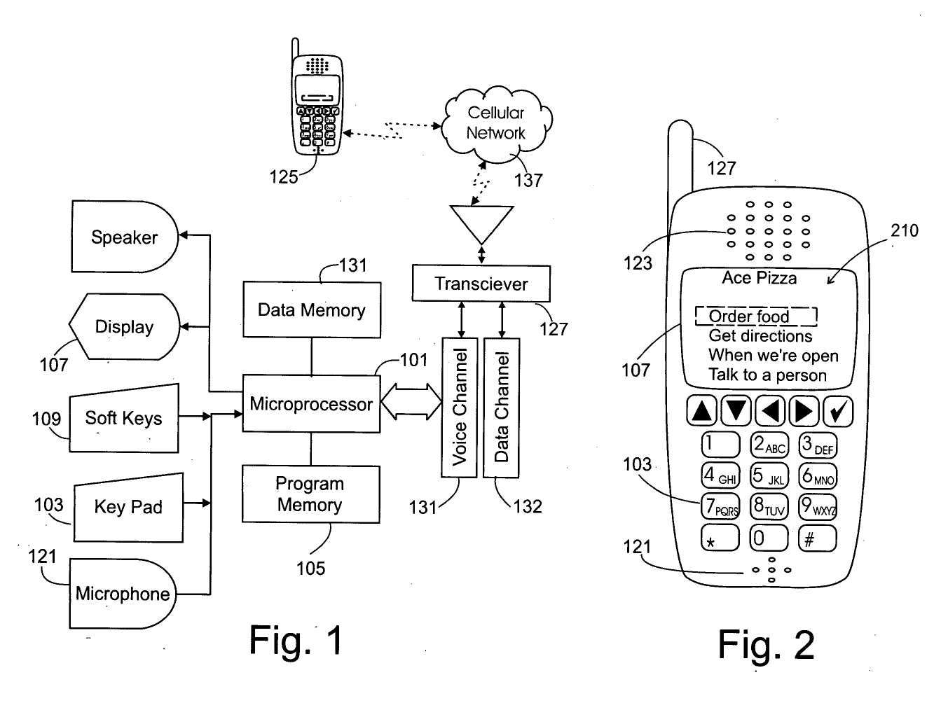

As described below, the invention may be used to particular advantage in connection with a cellular telephone and may be implemented using conventional components of the type commonly used in advanced cellular phone systems. The makeup and organization of these components is illustrated in FIG. 1 of the drawings and consists of a microprocessor 101 that executes routines initiated by the operator's manipulation of a keypad 103. Pressing a given key on the keypad 103 initiates a routine defined by a stored program in the program memory 105. The cellular phone further includes a display 107 that typically takes the form of a small, backlit monochrome or color LCD panel. The panel may be used to display a menu of items that may be selected by the user using “soft keys” seen at 109 that are visually associated with the displayed menu items. U.S. Pat. No. 5,737,394 entitled “Portable telephone apparatus having a plurality of selectable functions activated by the use of dedicated and/or soft keys,” the disclosure of which is incorporated herein by reference, describes the manner in which both the dedicated keys of a keypad and soft keys may be used in combination to implement a menu driven control arrangement for a cellular telephone. Alternatively, as will be described in more detail in connection with FIG. 2 of the drawings, the functions performed may be displayed as a list of options and cursor keys may be used to invoke selected functions and submenus identified on the display 107.

The cellular telephone further includes a microphone 121 for capturing spoken voice signals from the operator, a speaker or earpiece 123 for delivering audible sounds to the operator, and a cellular transceiver 127 for sending and receiving radio frequency transmissions to and from the cellular telephone via the cellular network (and/or the public switched telephone network) to a remote telephone station set as illustrated at 125 by a cellular phone having like functionality.

Note that, while the embodiment of the invention describes here uses a cellular telephone, the present invention is equally applicable to wired telephone station equipment connected to the public switched telephone system as well as with telephones which communicate in whole or in part via the Internet using VOIP connections. VOIP voice connections may be controlled using the Session Initiation Protocol (SIP), an application layer control simple signaling protocol. SIP is defined and described in RFC 2543 and is a textual client-server based protocol SIP that is designed as part of the overall IETF multi-media data and control architecture currently incorporating protocols such as RTP, the Real-time Transport (RTP) Protocol (defined in RFC 1889). RTP provides end-to-end network transport functions suitable for applications that require a mechanism for transmitting real-time data such as audio, video or simulation data, over multicast or unicast network services. The SIP/RTP mechanism is accordingly a further example of the mechanism by which telephone homepages may be transmitted via the telephone connection established for handling voice communications as contemplated by preferred embodiments of the invention.

The microprocessor 105 includes analog-to-digital conversion means for converting analog voice signals from the microphone 121 into digital form for storage in a data memory 131. In addition, using a text-editing program stored in program memory 105, the keypad 103 may be used to compose text messages, which are stored as character data in the data memory 131. Data memory may also used to store data in the form of text, graphics, video and audio which is transmitted to remote parties as one or more “homepages” as described in more detail below.

As used here, the term “homepage” refers to a graphical visual presentation displayed to the user of a telephone stationset which contains information transmitted to the stationset from a remotely located telephone stationset and which typically contains information about, or provides functions or services supplied by, the remotely located telephone stationset. A “homepage” may also include audio content produced for the listener from a transmitted text file (using text-to-speech conversion) or a transmitted audio file. The term “homepage” is not meant to imply that the presentation consists of only a single page, since the presentation transmitted to and rendered by the stationset may include multiple pages and functions, typically selected by the listener from options provided by the transmitted homepage. As discussed later, the “homepage” may typically take the form of a text file including markup that defines a sequenced presentation of media segments to the listener who can view and interact with a visual presentation displayed on the screen of the stationset. The text markup file which defines the “homepage” presentation may take the form of a SMIL or VoiceXML markup file, or a combination of these, that is transmitted to and executed by the listener's stationset (e.g. a calling party's cell phone) as discussed in more detail below. Typically, the homepage markup file is automatically transmitted from a called party to the calling party at the time a telephone connection is first established, in the same way that a World Wide Web homepage is transmitted from a Web server to a Web browser when the browser first visits that Web site.

The cellular system transmits and receives both voice signals to provide conventional voice communications as well as data signals which include displayable telephone homepages and interactive command and selection data. The cellular phone may be implemented, for example, using available technology such as the Motorola's iDEN i730 multi-communication device which provides a conventional, bidirectional audio voice communications channel at 231 as well as the additional TCP data communications channel 232. The iDEN i730 includes a built in processor 101 which can be programmed using the Java 2 Platform, Micro Edition, also known as the J2ME™ platform, which enables developers to easily create a variety of applications, as described in the i730 Multi-Communication Device J2ME™Developer's Guide, Motorola Corp. (2003).

FIG. 2 shows the exterior of an illustrative cellular telephone handset which houses the components shown in the block diagram of FIG. 1 and which employees the same reference numerals to identify the same components shown in block and pictorial form in FIGS. 1 and 2. The handset uses a conventional numeric keypad 103 for dialing and soft keys whose function depends on the content shown on the display 107. The soft keys include an UP cursor key 211, a DOWN cursor key 212, a LEFT cursor key 213, a RIGHT cursor key 214, and an OK key 215.

When a menu screen is displayed as seen at 210, the cursor keys 211-214 are used to highlight a selected one of several displayed labels, and the OK key 212 is used to invoke the operation designated by the selected label. For example, as seen in FIG. 2, the display screen 107 may display a scrollable listing of labels each of which specifies a particular one of a collection of prerecorded messages. By pressing the UP and DOWN cursor keys 211 and 212, the user may highlight a selected label on the scrollable list, and may select the highlighted message by pressing the OK key 215.

As described in more detail in the above-noted U.S. Patent Publication No. 2005/0153729 A1, the cursor keys may be used to select and transmit prerecorded messages to a calling party when it is inappropriate for the cellular phone user to speak, such as when the phone “rings” in a silent “vibrate” mode when the user is in a meeting or a theater. In these situations, the user may select and transmit a desired message to send to the calling party using the cursor keys without disturbing others. In some situations, however, such as recording spoken messages or entering text messages, voice commands may be used to advantage. The program memory 105 may include voice recognition routines for converting spoken commands into interface commands for selecting and initiating functions. In order to differentiate conventional speech from voice commands, a selected soft key or dedicated key, or a unique spoken command, may be used to place the device in voice command mode. In voice command mode, the user may select and invoke a particular function by speaking the word or words corresponding to one of the displayed labels. To enter a text message, the user may speak the names of letters, numerals and punctuation marks. In each case, because the total vocabulary of acceptable spoken commands is limited, a speech recognition program of limited capability of the kind now commonly incorporated in cellular telephones to implement voice commands may be used.

As contemplated by the present invention, the programs stored in the program memory 105 enable the operator to initiate and perform a number of interrelated functions, any one of which can be performed by beginning with menu as illustrated at 210 in FIG. 2. In the preferred embodiment of the invention, The menu may take the form of a “homepage” which is transmitted to the telephone of the calling party from the called party before or after the called party answers the incoming call. By way of example, the called party may be a merchant such as a pizza delivery service. When the telephone station equipment operated by the pizza service is dialed, the menu illustrated by example at 210 is transmitted to the calling party by or on behalf of the called party.

In some cases, the menu options may provide call forwarding functions. Thus, if the calling party to whom the homepage menu is displayed selects “ORDER FOOD” the incoming call may be forwarded to an order taker at the pizza delivery service. If the caller selects “TALK TO A PERSON,” a further menu or set of menus may be displayed which enable the caller to select a particular person's name and have the call forwarded to a phone located near that that person. If the caller selects on the homepage menu options shown at 210 (“GET DIRECTIONS” OR “WHEN WERE OPEN”), the caller may be sent an automated voice recording as well as a visual display giving directions to the pizza restaurant or given its hours of operation.

The user may make selections from options presented on the displayed homepage by using the cursor control buttons to navigate to the menu item and then pressing the enter key. A standard format for telephone homepage display data may be used to associate displayed options with data message content sent to the source of the displayed page to indicate that a remote user has selected a particular option. The command may be sent via the data channel 232 seen in FIG. 1.

As used here, the term “telephone homepage” refers to the displayable data that is transmitted from or on behalf of one telephone user to another via a dialup telephone connection (using the public switched telephone network (PSTN) and/or a cellular network) either before or during a telephone conversation between the two parties. The term “homepage” is chosen because, like World Wide Web homepages, telephone homepages are graphical presentations of text and/or images that are transmitted to and displayed by a display screen visible to a remotely located user who has established a telephone voice connection with the remote party that publishes the telephone homepage. Like World Wide Web homepages, telephone homepages typically provide information that describes the person or entity to whom a dialup telephone or cellular number is assigned, and also provides executable options to the person for whom the telephone homepage is displayed. Unlike World Wide Web homepages, telephone homepages are sent via a dialup telephone communication connection which may, but need not, include the Internet as all or part of the communication link. Moreover, although HTML, XML or some other markup language may be used to convey text and graphics for display, as well as to imbed information describing one or more executable options made available to the telephone homepage viewer, other data formats for conveying telephone homepages to the recipient may be used.

At the same time, the calling party placing an outgoing call may transmit his or her telephone homepage to the called party for display when the called party answers. Just as caller ID shows up on a phone before the phone is answered, the homepage of the party calling may be displayed on the phone of the party being called even before the call is answered. As is the case with caller ID (where privacy options may be chosen by a caller to prevent caller ID information from being displayed, both the caller and called parties can enable or disable the telephone homepage display, and when enabled, can choose between different homepage displays which may be appropriate. The particular telephone homepage that is transmitted may be automatically selected based on a preset time schedule, or may be selected in response to the selection of a particular number dialed on the caller ID number associated with an incoming call. In this way, the content of the homepage may be automatically tailored to different calling situations.

Multiple homepages may be displayed in sequence, with each on staying on the screen only long enough to be read, understood and a menu option chosen if desired. The homepage could be designed or instructed to be persistent, that is lasting for some or all of the phone call. The user receiving a homepage display would also have the option to override or dispense of a specific homepage display if the screen display was needed for some other purpose.

While a telephone homepage may take the form of a simple text-based menu as described, it could take other forms as well. For instance, a homepage could take the form of or include a video file, or a live video of the caller at the time of the call is placed which the called party could view without answering the phone (akin to the peephole through which one views visitors to a room before opening).

As described in the above-noted U.S. Pat. No. 5,732,216 entitled “Audio message exchange system,” the multi-media content of a homepage may be defined and synchronized by creating an electronically readable file of text characters consisting of natural language text and embedded markup tags of the type used in HTML and XML to identify multi-media files which are synchronized at playback with spoken text. The spoken text may be created by using speech synthesis to translate the natural language text in the file of text characters into spoken audio voice signals reproduced to a listener at the same time that visual displays from the text of the script file, or from audio or video files identified in markup tags in the script file, are visually displayed for the user. Thus, in one simple form, a file of text characters may be converted to spoken text which is reproduced to a listener at the same time the listener views a synchronized image “slide show” or video clips.

As further described in the above noted U.S. Pat. No. 5,732,216, the file of text characters may further include markup tags that specify a position relative to said natural language text where a responses are provided by and accepted from the stationset the operator. Speech synthesis processing is employed to convert the electronically readable file of text characters into a corresponding audio file of spoken natural language. The response markup tag in said file of text characters are converted into timing data indicating a position in the audio file at which reproduction is temporarily suspended while a spoken response from the listener is recorded. The spoken response may be recorded as an audio file, or alternatively, the response may be recognized by speech recognition routines to convert the response into data values. In this way, the file of text characters can include not only indications of visual content to be displayed in synchrony with the spoken natural language text, but also provide a mechanism for recording spoken responses, or data values indicated by spoken responses or by keypresses, thus forming an audio and/or visual questionnaire which can be transmitted to the script playback device which can the return response data to the source of the questionnaire or some other destination designated in the script file or by the operator.

The audio player described in U.S. Pat. No. 5,732,216 receives the markup file and employs it as a “selections file” or playlist that controls the synchronized multi-media reproduction of audio information delivered to the player' speakers and video display. The markup file can take the form of an HTML text file that includes conventional tags, such as <img> tags that identify referenced image files by name which are reproduced on the display at times which are synchronized with the audio content based on the position of the image tag in the markup file. A non-standard <IMGOFF> tag may be imbedded to indicate when the presentation of a given image ends. Other tags may be imbedded in the file to indicate “highlight” and “topic” passages, and the beginning and ending of content segments, to provide markers that allow the listener to “surf” within the program content, skipping forward or backward to the beginning of individual segments, and performing “jumps” to other portions of the content specified in linking tags. Still further tags, such as conventional HTML <input> and <textarea> tags may be used to designate positions in the audio playback where reproduction is paused and the listener is given the opportunity to enter spoken responses which are recorded, supply spoken responses that are converted into requested data values (e.g. “YES/NO” selections), or to use the player's keyboard to provide keypress responses as times indicated by the input tag locations. The resulting data supplied by the listener is then transmitted to a designated destination, typically the requesting source from which the markup file was transmitted.

The markup file for controlling the operation of a telephone stationset may advantageously be expressed in one or a combination of the industry standard markup languages now in widespread use for implementing voice applications: SMIL or VoiceXML. SMIL is used to control visual presentations on the display screen, as well as accompanying audio clips, whereas VoiceXML implements a voice-only system that uses a telephone voice connection (without a display) to provide an interactive information exchange with a server, normally invoked by calling a particular called telephone number which invokes a server process that interprets a specific VoiceXML control script. As contemplated by the present invention, a markup text file such as a SMIL file can be used to control a graphical homepage presentation on the calling party's screen whereas (the same or different) markup file containing tags of the type used in VoiceXML files may be used to provide a variety of voice-based functions, such as translating text into spoken prompts and translating the listener's spoken responses into data or commands that control functions performed by the stationset or which invoke functions or services at the remote stationset.

The “Synchronized Multi-media Integration Language” (SMIL, pronounced “smile”) standard, promulgated by W3C, can be used to enable simple authoring of interactive audiovisual presentations which may be transmitted automatically to the calling party from the called party at the time a telephone connection is initiated. SMIL is now used in audio playback devices (hardware and software) such as the Apple QuickTime player and the RealAudio player to provide “rich media”/multi-media presentations which integrate streaming audio and video with images, text or any other media type. SMIL is an easy-to-learn HTML-like language, and many SMIL presentations are written using a simple text-editor. In accordance with the present invention, SMIL presentations may be authored by telephone users, and the SMIL file may be transmitted (along with whatever media data objects needed for reproduction) to remotely located stationsets which are capable of executing the script file. The RealAudio player is described in U.S. Pat. No. 6,934,837 issued to Jaisimha et al. on Aug. 23, 2005 entitled “System and method for regulating the transmission of media data,” the disclosure of which is incorporated herein by reference. The Apple QuickTime player, a browser plug-in, may be controlled by either by SMIL markup or HTML markup files as described in the “SMIL Scripting Guide for QuickTime,” Jun. 4, 2005 and the “HTML Scripting Guide for QuickTime,” Apr. 29, 2005, available from Apple Computer, Inc. Additional information about SMIL, and SMIL player software and applications, can be found at the W3C website at www.w3.org/AudioVideo. As contemplated by the present invention, SMIL markup files, together with any referenced media objects specified in the SMIL files, are transmitted to and reproduced by the listener's telephone stationset in the same way that these files are reproduced by multi-media software players such at the RealAudio and QuickTime players that execute on personal computers.

The Voice Extensible Markup Language (VoiceXML) standard has been developed and promulgated by the VoiceXML Forum and is described at www.voicexml.org. The VoiceXML Forum is an industry organization formed to create and promote the VoiceXML standard which in now widely used in a variety of speech-enabled applications. VoiceXML has also been made the subject of a draft recommendation by the World Wide Web Consortium (W3C) which, in its most recent form, is entitled “Voice Extensible Markup Language (VoiceXML) 2.1 Last Call Working Draft,” issued on Sep. 15, 2006, currently available at http://www.w3.orgVoice/. As explained in that document, VoiceXML forms part of a suite of evolving markup specifications which bring the benefits of Web technology to the telephone, enabling Web developers to create applications that can be accessed via any telephone, and allowing people to interact with these applications via speech and telephone keypads and voice dialogs, speech synthesis, speech recognition, telephony call control for voice browsers and other requirements for interactive voice response applications, including use by people with hearing or speaking impairments. Some possible applications which have been envisioned for VoiceXML include:
Accessing business information, including the corporate “front desk” asking callers who or what they want, automated telephone ordering services, support desks, order tracking, airline arrival and departure information, cinema and theater booking services, and home banking services.
Accessing public information, including community information such as weather, traffic conditions, school closures, directions and events; local, national and international news; national and international stock market information; and business and e-commerce transactions.
Accessing personal information, including calendars, address and telephone lists, to-do lists, shopping lists, and calorie counters.
Assisting the user to communicate with other people via sending and receiving voice-mail and email messages.

VoiceXML has been widely used to implement telephony functions at the location of the called party, particularly Automatic Call Director (ACD) systems. See, for example, “A Multi-Modal Architecture for Cellular Phones” by Nardelli, Orlandi and Falavigna, ICMI'04, Oct. 13-15, 2004, State College, Pa., USA., ACM publication No. 1581139543/04/0010. VoiceXML may be used in combination with CCXML, the Call Control Extensible Markup Language, which provides telephony call control support for dialog systems, such as VoiceXML, and is described in “Voice Browser Call Control: CCXML Version 1.0.” W3C Working Draft, 29 Jun. 2005. Typical VoiceXML applications employ the combination of text-to-speech and speech-to-text processing engines that run on a server, interpreting speech signals sent from the client as interactive commands, and translating text strings in the VoiceXML file into speech that transmitted to and reproduced by the client device. Server-based text-to-speech and speech-to-text products are available from a variety of vendors including IBM, Motorola, and Nuance.

Software which is executable on a cellular, VoIP or wired telephone stationset (as opposed to a remote server) to perform speech recognition functions is also available; for example, the VoCon® Mobile family of speech recognition software available from Nuance is used for Voice Activated Dialing applications on mobile handsets. VoCon Mobile XGT is an embedded, phoneme-based speaker independent speech interface solution for mobile devices, combined with voice feedback for recognized name, number and command confirmation. Text-to-speech software executable by the stationset is also available to convert text strings in a received “homepage” VoiceXML or SMIL file into speech. For example, Nuance's RealSpeak™ Mobile family of text-to-speech products, typically used for SMS and email reading, may be employed to provide spoken audio output in a range of languages and voices.

As contemplated by the present invention, text markup files of the kind disclosed in the above-noted Audio message exchange system U.S. Pat. No. 5,732,216, preferably implemented in accordance with the VoiceXML and/or SMIL standards, may be used to create a “homepage” that is automatically transmitted to a calling party from a called party at the time the call is placed and then executed by the cellular or wired telephone stationset to present the calling party with an audiovisual presentation from the called party in the form of information, interactive menus, and information gathering questionnaires that produce response information that is returned to the called party, etc. In accordance with the invention, and as described in the Audio message exchange system U.S. Pat. No. 5,732,216, the transmitted markup file is sent to and interpreted by the stationset of the party to whom the multi-media presentation is made. The markup file identifies external multi-media data objects are preferably transmitted to and stored at the stationset in advance of the time when those files are reproduced. Thus, while the stationset user is being presented with a preliminary portion of the presentation defined by the markup file, media objects identified in the file may be transmitted (either by being “pushed” along with the markup file from the called party, or “pulled” by a request from the stationset which pre-scans the markup file for referenced media objects to be reproduced later).

Audio content could be transmitted along with the visual homepage content, although typically the audio playback would be discontinued automatically when the audio channel is needed for voice communication. Therefore, if audio accompanies the visual homepage display, either party should be able to mute at any time. Alternatively, the audio could automatically shut off or be reduced in volume when the phone was answered or either party speaks. Other user controls could be made available for managing audio volume and controlling when audio was played (perhaps only allowing from certain numbers or types of numbers). Mechanisms for transmitting prerecorded audio message content are described in more detail in the above-noted above-noted U.S. Patent Publication No. 2005/0153729 A1 by Logan et al.

The called party may dynamically construct markup files defining “homepage” presentations constructed on the fly. Thus, the homepages transmitted to a calling party from a called party could vary by time of day, or rotate randomly, or be generated in some way by modifying other images. Specific homepages could be sent to specific calling numbers or types of numbers. For instance, a more personalized homepage could be sent to all of one's friends listed in a stored directory by the called party.

When a homepage includes text, the text may change or scroll to present more information than will fit easily onto the display screen, and the text may be formatted by the receiving device in accordance with its capacity using, for example, The Wireless Application Protocol (WAP), a messaging service for digital mobile phones and other mobile terminals that will allow users to see Internet content in special text format on special WAP-enabled mobile phones and other handheld devices having relatively small display screens.

Finally, the homepage could be the beginning of a continuing stream of text and audio-visual information sent in parallel with the audio phone call. Thus, when one called a pizza delivery service, the homepage seen at 210 might initially be displayed, and then after that advertising content could be displayed.

The homepage idea differs in some significant ways from today's Internet-enabled phones, which also present graphics, text, and audio on the cell phone. First, in these cases the user must take specific actions to fetch certain web pages, or portions thereof. In contrast, and as contemplate by the present invention, this information is automatically pushed at the calling parties. Secondly, with today's Internet and WAP phones, the caller typically cannot access Web data while engaged in a call, whereas the present invention contemplates the presentation of displayed information to the user simultaneously with, and typically enhancing rather than substituting for, a conventional telephone conversation or information exchange. Moreover, in today's systems, called and calling parties do not create the displayed content, nor can the displayed content be used to control call handling features, such as call forwarding, voice mail. In accordance with the present invention, stationset users of all kinds can create their own interactive “homepages” which are automatically pushed to calling parties at the time the call is initiated, or on request by the calling party, or when requested by the called party.

With the multi-media cell phone, conventional telephone usage need not change. Dialing a phone number remains the same familiar routine and user speaks and listens during a telephone conversation in the usual way. However, the user has the benefit of additional (primarily) visual information to annotate the voice audio which appears automatically on the telephone display screen without requiring the phone user to do anything new. Users can thus have the benefit of added information and functionality, or can ignore it and use the phone the way they always have done.

A telephone homepage (typically a SMIL and/or VoiceXML file and ancillary media data objects) may be produced and transmitted to one telephone stationset (typically operated by a calling party) from a telephone station equipment operated by a second telephone user (typically a called party), or may be produced and transmitted on behalf of the called party by a shared service. In one implementation of the invention, one or more telephone homepages may be stored in and transmitted by the telephone station equipment such as a wired telephone, a VOIP telephone connected to the Internet by a wired or wireless connection, or a cellular telephone handset. In other implementations, telephone homepages may be stored and transmitted by a telephone call handling service, such as a provider of VOIP or dialup telephone services, on behalf of its subscribers. For example, telephone homepages may be stored and transmitted via telephone connections supplied by a hosted VOIP service. Subscribers to such services are assigned telephone numbers in the dialup PSTN or a cellular network, and the service routes incoming calls directed to those numbers to subscribers via connections that may include a VOIP Internet link, or via the PSTN or a cellular network, or a combination of these links. These services also provide outgoing call connections via one or a combination of these pathways. An example of such a service is described in U.S. Pat. No. 6,445,694 issued to Robert Swartz on Sep. 3, 2002 entitled “Internet controlled telephone system,” the disclosure of which is incorporated herein by reference. Other examples include the hosted VOIP services provided by Vonage Holdings Corp. of Edison, N.J. and the Verizon VoiceWing service offered by Verizon Communications, Inc. of New York, N.Y. Other services and equipment, such as PBX equipment, VOIP gateways, telephone central offices, call answering services, and the like which are capable of connecting to a telephone communications link to transmit telephone homepages to remote telephone station equipment via a dialup telephone connection may implement the invention.

In its preferred embodiment, a mechanism should be available to the telephone user to define the content and function of telephone homepages that are stored and automatically transmitted on the user's behalf. To this end, a World Wide Web site accessible to the telephone user may be employed to permit the user to define the content and functionality of one or more telephone homepages that are to be transmitted on the user's behalf. Access to the content of the telephone homepages should be made secure by suitable user name and password protection mechanisms. Typically, one or more template telephone web pages may be established as initial defaults, with standard information describing the individual user and one or more standard options being preloaded into the template, which may thereafter be edited by the user as desired.

In addition to information content which the user may wish to make available to those with whom telephone connections are established or requested in “published” telephone homepages, a user may be provided with “private homepages” that provide the user with call-progress information and selectable options that are not available to remote parties with whom the user establishes telephone connections. Examples of the information and call handling options that may be made available using private homepages include call control and call-in-progress control functions that are accessible display options by which the user can submit preference data which specifies how calls are to be handled (similar to the manner in which call handling functions are specified using a Web browser Internet interface as described in the above noted U.S. Pat. No. 6,445,694). Specific examples of telephone call handling functions that may be established and controlled using one or more private telephone homepages include:
(a) Automatic call back to an internal extension when a call is not answered, or a busy signal is received (also called “camp on”);
(b) Bridged call (line) appearance whereby the same phone number can appear and be answered on multiple phone sets;
(c) Conference calling providing an audio path for multiple parties on a single call.

Conference calling may be setup in advance using one or more telephone homepages that can be accessed by the user and telephone homepage options can be used to control the conference, including adding or removing parties, displaying the identity of participants who have joined the conference, etc., during the course of the call;
(d) Call blocking: identifying telephone numbers (or callers without caller ID information) from which calls will not be accepted, and/or routing such calls directly to voicemail;
(e) Call forwarding, including:
   (i) Call forward all: user can redirect all calls to another station or location,
   (ii) Call forward on busy: user can redirect calls to another station or location when busy, and
   (iii) Call forward on no answer: user can redirect all calls to another station or location after specified number of rings;
(f) Call hold: a displayed telephone homepage option places incoming call on hold, and thereafter reestablished the connection on request;
(g) Call pick-up: A user can answer a call ringing on another extension displayed on a telephone homepage where both extensions are part of a pickup group;
(h) Call park/retrieve: a user can put a call on “hold” (to a virtual extension) and then pick up from another phone in the system;
(i) Call restriction: Block outgoing calls to certain numbers;
(h) (Last) call return: a telephone homepage option that can be selected to call the last incoming number;
(j) Call transfer: redirect an answered call to another user, or transfer unanswered calls can be done on either a “blind” or “consultative” basis (in the consultative mode, the transferor converses with the destination first);
(k) Call waiting: enabled by a private telephone homepage such that currently connected users an audible beep to identify that another call is pending;
(l) Caller ID: a telephone call-in-progress display shows the name and/or number of the calling party obtained from caller ID information (or displays the called number for outgoing calls);
(m) Caller ID Block (per user, per call, per destination): a private telephone homepage option can be used to block delivery of caller ID per destination or per call;
(n) Direct inward dial (DID): where PBX phones are dialed with an E.164 number, without a separate extension or two-stage dialing, a telephone homepage may be used to establish relationships between the dialed number and specific extension;
(o) Direct transfer to voice mail: automatically redirects all calls to voicemail by selecting a single option on a displayed private telephone homepage;
(p) Distinctive ringing: establish ringing with different characteristics, depending, for example, on whether a call is internal or external, or calls from particular numbers;
(q) Do Not Disturb: by selecting a displayed private telephone homepage option, the user's phone can be made to appear out of service;
(r) Follow me: allows multiple, disparate user-defined telephone numbers to ring simultaneously when a single telephone number has been dialed;
(s) Free seating/hoteling: a user can move from one location to another and access all his/her calls, features, button mappings, etc., without intervention from the telephone service provider (including a PBX administrator);
(t) Last number redial: a private telephone homepage option causes last outgoing call to be re-dialed;
(u) Message waiting indication: a visual cue displayed to the user indicates when one or more voicemail messages are pending, preferably with an indication of the pending message count and a convenient option that permits the user to list and playback or delete individual messages;
(v) Missed call indicator: List missed calls with caller ID information when available, preferably with a convenient displayed option to dial the displayed caller;
(w) Mute: a mute button to disable the microphone;
(x) Speed dial. Private telephone homepage display of frequently called numbers which may be selected to place outgoing calls;
(y) Volume control: Controls audio volume for speaker, handset, headset, ringer, either together or separately; and
(z) Whisper page: a private telephone homepage lists active calls in a “PBX group” or other identified telephone numbers, and permits the user to bridge into an existing call, so that only the intended party will hear their “whispers”.

As will be apparent from the number of potential controller call handling functions listed above, multiple related functions are best organized in a “drill down” hierarchy of private telephone homepages. In addition, since many of these functions may only be controlled by the telephone service provider or PBX to which individual telephone station equipment is connected, these private telephone homepages may be dynamically transmitted to the individual station equipment on request, or downloaded in advance to the telephone station equipment as needed to reflect currently available options. The same entity that provides these call handling options may also store and transmit “published” telephone homepages to other stationsets (typically operated by calling parties) on behalf of the user, or the user's station equipment may store and transmit published telephone homepages and include an option to access the private homepages to control functions of the type listed above.

Text Mail-Visual Information Tied to Voice Mail

Once a connection was established, this “sideband” of information can be used for other purposes. In particular, if a voice mail system answered the phone, such an exchange could be supplemented by a homepage transmitted from voicemail system of the called party to the stationset of the calling party, who is presented with information and options now commonly offered using spoken prompts which invite DTMF keypress or spoken responses.

As described in the above U.S. Pat. No. 5,732,216 entitled “Audio message exchange system” issued to James D. Logan, Daniel Goessling and Charles G. Call on Mar. 24, 1998, tags in the markup file which are interpreted and executed by the telephone stationset, allow the stationset to accept and record spoken “comments” or “messages” from the listener which can be returned to the requestor or transmitted to some other designated telephone stationset. Comments or messages may be shared with other users, or made available only to the author of the markup file which requested the comment, or to a host system, or some other destination specified by the markup file author or by the listener who records the comment. By sending comments to script file source, the user can make a direct but private response to anything contained the homepage presentation from that source. Particular advertisers or other content providers who produce some or all of the homepage presentation may encourage such comments and offer the person to whom the homepage is presented credits or other incentives to those who are willing to make comments.

As further described in U.S. Pat. No. 5,732,216, the ability to direct comments to specific people allows the system to provide voice-mail like functions among telephone users. Using speech recognition capabilities built into the stationset, dictated comments may be translated into text messages such as SMS messages, E-mail messages, or images of the text content sent to a facsimile receiver. Alternatively, the comment could be transmitted as an audio file attachment to an E-mail message (e.g. as a RealAudio file). In addition, the comment may simply be stored in the stationsets memory for future reference.

In fact, voice mail interchanges could be partially or completely replaced or supplemented with “text mail” interchanges using, for example, VoiceXML to define both the spoken and text menu displays presented to a caller by the mail systems. Such a text mail interface would consist of homepage presentation of both text and graphics (and perhaps video) defined by a SMIL file, or an VoiceXML file, pushed to the caller who accessed what would previously have been a voice-(only)-mail type system. The caller accessing such a system could use the phone's keypad, or respond verbally, to the menus presented by the mail system.

Ideally, the user of a voice mail system would have the option to use text, voice, or both. This preference could even be pre-set and read by the current voice mail system.

When the homepage interface, the text message displayed on the calling party's screen typically provides a displayed menu of various options being offered in parallel in audio form. Because of the greater efficiency resulting from the simultaneous display of multiple options, compared to the serial presentation of options described by spoken prompts in conventional voice mail systems, the selection of desired functions can be more efficiently accomplished.

Furthermore, homepage voice mail system could have a memory. The caller could quickly go back over previously asked questioned and take a different branch through the menu. Alternatively, the memory could persist over time and be recalled during a subsequent call. In this case, the called party's stationset phone would recognize calling party's number using caller ID or ANI data, retrieve a history of prior responses to menu options provided by the calling party, and transmit a dynamically produced homepage tailored to the typical choices previously made by that party. By way of example, if homepage from a called PBX typically presents a listing of persons to whom calls can be directed via the PBX, a dynamically generated homepage can list frequently called person first, simplifying the selection process for most repeat callers.

Parallel Text and Audio

Today, text messaging is a singular activity. That is, users cannot use text messaging while engaged in an audio phone call. By using a sideband or alternative data channel, text messages and homepage script files can be exchanged and displayed while a voice phone conversation is in progress. Note that, for many purposes, text messages (e.g. SMS messages) and script file homepages can perform similar functions, although in general the multimedia and interactive capabilities of a script-produced homepage substantially exceed those of simple text messages.

Given the difficulty in preparing text messages or script files with a keypad-type input device, this feature would be most usable if the messages and/or script files were prepared in advance. In a manner similar to that described for voice messages in U.S. Pat. No. 6,816,577 issued on Nov. 9, 2004 to James D. Logan entitled “Cellular Telephone with Audio Recording Subsystem,” a user could have previously authored script files and text messages that could be easily accessed, for example by scrolling through a list or using “speed dial” numbers assigned to the text messages.

If the list of messages and homepage scripts was long enough, they could be arranged in the equivalent of folders. Alternatively, a search box could be used. The search box would retrieve likely results as the search term was being typed in a manner similar to how today's cell phone retrieves names from a list of names. The messages and homepages could also be stored in alphabetical order or by chronological order for those that had been used in the past. The phone would offer multiple means to access such list.

Such retrieved text messages and homepages could then be easily sent to the other party on the audio call by hitting the equivalent of the “send” button. Thus directions to one's house could be pre-stored. If a caller requested such directions, the party giving directions would retrieve them from a list of other prepared text messages or script files and send them over the data path where they could be viewed on the screen display of the phone being used by the party on the other end of the audio line. A script file containing directions might include an <IMG> tag or the like which would display a map giving directions to the location from which the script file is being sent. A GPS cell phone capable of producing a map showing the operator its current location could send that map via the telephone connection to the remote party. Similarly, a transmitted homepage file might identify an image file recently produced by a camera built into the phone as part of a homepage or SMIL-style slide show delivered to the remote party.

Note that it might be desirable for the information to be displayed on the phone of the sender as well as that of the receiving party. If there was information being sent in both directions, the phone screen could be divided to show both sets of data. Alternatively, the presentation could be time-sliced, first showing one set of data, then the other.

As multi-tasking knows few bounds, it would be desirable to allow the user to send a text message to a phone different from the one with which the audio conversation is being conducted. Thus, a teenager on the phone with one friend might wish to broadcast a homepage script file to a one or more friends who are not parties to an existing telephone conversation in the same way the text messages may be sent to others.

In particular, it would be useful to be able to send a home page or text message a caller that was has been placed on hold. Thus, a user might retrieve or type in a script or message such as, “I'll be on this call for five minutes Do you want to hold?” In this situation, where the other party was already connected to the text-sending party, the party receiving the text message could respond immediately and such response could be seen by the first party.

Virtual Answering Machine

Today, if the party being called does not answer their phone, the only option is to leave a voice message. Alternatively, a caller, upon finding nobody home, could compose a text message and send it to the last party called.

Using this invention, however, a “virtual answering machine” could be created that would save homepage information pushed to a given phone by a remote party. In its simplest implementation, one would be able to automatically send and leave a text message or script file on a virtual answering machine by retrieving a message or homepage script from a list of pre-constructed messages. The message or homepage sent could be automatically created or selected and be a function of time,-person called frequency of calls to or from a number, etc. The person would not have to hang up to leave the message but could do it as part of the call-either while the phone was ringing (in which case the option to not the leave the message would exist in case the call was answered) or after an answering machine answered.

The party being called, instead of playing back a laborious audio announcement, could instead of, or in addition to, send a text message. Such a text message could be replied to with a text or audio message or both.

As the proposed data pipe could handle graphics and audio-visual information, the calling party would have the option of sending and leaving not only text messages and homepage scripts but audio messages mixed in as well. Graphics and video files would also be able to be sent and stored, typically with an accompanying identifying script file that would identify the file and control its reproduction.

The receiving party on the other hand, would have the option of refusing certain types of media. And in a feature analogous to a spam filter, some or all forms of media from specific phone numbers could be screened out as well.

Advertising

In order to gain universal acceptance for the homepage concept and ubiquitous use of the sideband channel, network operators would be expected to offer free, basic homepages. Enhancements above and beyond a basic homepage could become revenue opportunities for such operators. In particular, in much the same fashion that cell phone owners pay for ring tones, phone operators could charge for fancy or duplicate homepages.

In particular, once a connection had been established between a “consumer” (which could be a purchasing business and not just an individual) and a “commercial party”, the commercial party could use the sideband to push advertising to the other end. In the case of a restaurant, it could be directions or that day's specials, or an ad of any sort.

The consumer would be able to interact with the ads and make selections to get additional information, even while a conversation was in progress over the phone.

In a further embellishment, the commercial party could have the option (for which they might have to pay) for the person on their phone to see which options were being selected in real time by the consumer. This setup would be similar to ones used today on the Internet where a consumer calls a business while on their website and the customer service person is able to work with the customer as the site is navigated. Because the interactive capabilities provided by a homepage script file are robust, a merchant could transmit homepages that could be executed to perform complete sales transactions, including allowing the customer (calling party) to display products listings, display detailed product descriptions, see advertising, specify the quantity of particular items to order, and key in credit card numbers (transmitted in encrypted form) in payment for the selected goods.

The visual homepage and other ideas presented in this invention serve to bring the caller's eyes to the screen. This attention time could then be sold by the network operator to advertisers who would then place ads in part of the screen or time slice ads between displays of information from a calling party.

Either party could pay the operator to block ads from being displayed.

Saving or Sending

Another feature would be to allow the consumer of the information to be able to save screens of information (e.g. a received SMIL or VoiceXML file, and any ancillary media data referenced by that file) to the cell phone's memory, such memory residing either in the phone or at the server of the cellular provider. Such a feature would be similar to the history feature that a web browser has; that is, users could access previous screens of information by date, type of media, or phone number, or a combination thereof.

In addition, the consumer could request that some or all of the information (text, graphics, questions and answers) be emailed to an email address. This would require the inputting of one's email address at the time of the email request.

Identification Metrics

The information contained in a homepage file may advantageously include metadata, such as a user's email address, telephone number, or other contact information (such metadata not necessarily being displayed on the receiving party's phone screen), to be associated with a homepage. This metadata would allow a calling party to capture and retain information about a called party. The information may be recorded in a log file together with information describing the date and time of the call. Such metadata may also be pushed or pulled on demand after a connection is established. The availability of that information would permit, for example, a commercial party (other individual if it were an individual-to-individual call) to send information to another party's email address automatically, or when requested, without the requesting party being required to input their address. The addressing may be accomplished using the virtual addressing system described in U.S. Patent Publication No. 2005/0259658 (application Ser. No. 11/198,124) filed on Aug. 6, 2005 by James D. Logan and Charles G. Call entitled “Mail, Package and Message Delivery using Virtual Addressing,” the disclosure of which is incorporated herein by reference. As described there, telephone calls may be placed, packages may be mailed, and messages delivered to any destination using any available unique designator, such as a telephone number, an email address; or a user-created unique “virtual address.” This system permits, for example, email messages to be sent to the telephone number of a calling party obtained by the called party using caller ID functions (instead sending the email to that party's email address which may not be known).

Visual Call Lists

Today's phones present to users' handy lists of calls that were sent, received, and missed. If caller ID was present, a number will be displayed. If caller ID also had an associated name, that would be shown. And if the number was in the person's phone Rolodex, the name of the person, as shown in the Rolodex, would be displayed.

In this invention, in the interests of making such lists more visually interesting and informative, such lists would be composed of thumbnails of the homepages which identify and describe other parties. Names and numbers would be “attached” to such thumbnails. If a user wanted to see a thumbnail in more detail, it could be clicked on. Users could scroll up and down the list, and use the horizontal scroll keys to jump to a corresponding list of numbers or names.

In order to convey more information than an icon of a homepage, the calling party could request a substitution be placed in the list in place of the normal homepage. That is, any text or audio-visual information file could be the place holder in such a list. For instance, a spouse might substitute a short text message, “I miss you” in place of the homepage.

Alternatively, short text messages could become a standard piece of data associated with a missed call. For a missed call, such a short message could serve as a mini-message that might supplement a larger message left in audio or text form, much in the same way a “subject” line gives a reader a rough idea as to what an email contains.

Web Interface

Users would have the ability to set up the specific parameters of their multi-media phone via a web interface where a full keyboard, voice input, mouse, and other input devices would be available. In addition, graphic tools and data off the Internet would be available from which to construct homepages, write scripts to make homepages on the fly, and perform other set up functions. In particular, inputting lists of pre-constructed text messages would be easier to do on a PC. A rich set of SMIL authoring tools are listed by the W3C at www.w3.org/AudioVideo/ and VoiceXML tools are listed at www.w3c.org/voice.

Ring Tones

Another use for the data channel and ability to push information to the party being called, would be the ability to control the ring-tone of the party being called.

With this feature, the caller would select the ring-tone to be heard by the party being called. The party being called should be able to set parameter on the called telephone to allow or prohibit such an intrusion. Using the idea of categorized callers, users could allow or prohibit this intrusion only for certain types of callers, calls from specified numbers, or calls received at particular times.

To conserve bandwidth and/or speed the response of the system, a set of pre-recorded “ring-tone” files could be stored in the called station set, or in a storage location accessible to the called station set, and the calling party could then specify which of the stored ring-tones would be played to announce an incoming call. For example, a husband and wife could each load a set number of message-conveying ring-tones into their phones. The wife could call the husband and select the “I just want to chat” ring-tone, signaling the husband that he could send the call to voicemail if in a meeting.

Instead of playing a pre-recorded ring-tone file, the system could open a voice channel between the calling party's station set and the called parties “ring-tone speaker” so that the caller's voice can be heard by the called party instead of (or in addition to) ringing sounds before the called phone goes off hook. In this way, the caller can announce himself or herself or transmit a voice message or announcement in much the same way that a “squawk box” intercom is used.

In the same vein as the aforementioned ring-tone concept, the invention would also allow the party being called to control the ring-back tone (a tone that the user hears while waiting for the call to be answered).

This ring-tone, or ring-back tone, in addition to just being an entertaining sound, could be a meaningful message, such as a recorded voice announcement file. The called party might then hear, instead of or in addition to the normal “ringing” an announcement such as “This is Sam. Please pick up,” A message-bearing ringback signal could be selected by the party being called. Thus, somebody in a meeting or off-site exercise could set up their “pushed” ringback tone for that day to say, “I'm in meetings today but will pick up if possible”. In other words, this becomes a pre-connection message, much like one might hear on an answering machine. The message bearing ringback signal would thus operate in a fashion similar to “music on hold” messages, and could include an advertising message that plays until the called telephone goes off-hook to begin a voice conversation. Again, the message-based ringback tone could be customized to be different for different callers, different times of day, and different types of callers.

A ring-back signal which a caller hears while waiting for the called phone to go off hook could be selected by the calling party. This technique could, for example, indicate to the caller that “Your call will be answered shortly, in the meantime, press the star key on your phone to skip to next recorded message.” The caller this controls what they hear while waiting for a phone to answer.

The ring-back message a caller hears while waiting for the caller to answer may also be locally stored on the calling telephone and played back while the caller waits for a called party to answer. For example, it the caller wants to be reminded of some fact while waiting for a caller to answer, the reminder message may be pre-recorded for playback at that time. Thus, to help train children to use good phone habits, the following message may recorded: “Remember to identify yourself as soon as the phone is answered.” Or an automatically generated message might be created based on the called number, such as “Last call to this party was Tuesday at 10:34 am.” Note that messages of the latter type may also be displayed on the visual display.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A telephone system comprising, in combination:
a plurality of telephone stationsets interconnected with one another via a telecommunications network, each given one of said telephone stationsets comprising:
a speaker or earpiece responsive to audio signals for delivering audible sound to a human operator who operates said given one of said telephone stationsets,
a microphone for accepting spoken information from said human operator and converting said spoken information into a first voice signal,
a display screen for presenting visual information to said human operator.
a keypad for accepting keypress information from said human operator and converting said keypress information into command signals,
a communications subsystem connected to said telecommunications network for establishing a telephone connection via said telecommunications network with a remote location designated by a telephone number designating a called person or entity at said remote location,
one or more processors connected to said communications subsystem for receiving a script file transmitted from said remote location via said telephone connection and for executing said script file to perform a plurality of functions in a sequence, said functions including:
applying audible signals to said speaker or earpiece to deliver audible sounds to said human operator as specified by said script file,
concurrently presenting visual information designated by said script file to said human operator on said display screen, said visual information including a list of optional functions executable by said processor, and
executing a selected one of said optional functions in response to selection commands signals produced by the operation of said keypad by said human operator.

2. A telephone system as set forth in claim 1 wherein said script file is automatically transmitted from said remote location to said given one of said stationset when said telephone connection is first established.

3. A telephone system as set forth in claim 1 wherein at least some of said audible sounds delivered to said human operator are produced by voice signals produced by a human speaker at said remote location during a telephone conversation with said human operator and transmitted via said telephone connection from said remote location.

4. A telephone system as set forth in claim 3 wherein said one or more processors is programmed to perform a text to speech conversion process and wherein at least some of said audible sounds delivered to said human operator are produced by said text to speech conversion process from one or more text character strings included in said script file.

5. A telephone system as set forth in claim 1 wherein at least some of said audible sounds delivered to said human operator are produced by reproducing the audio content of a separate media data object that is external to but identified in said script file.

6. A telephone system as set forth in claim 5 wherein said one or more processors is programmed to perform a text to speech conversion process and wherein at least some of said audible sounds delivered to said human operator are produced by said text to speech conversion process from one or more text character strings included in said script file.

7. A telephone system as set forth in claim 6 wherein said one or more processors is programmed to perform a text to speech conversion process and wherein at least some of said audible sounds delivered to said human operator are produced by said text to speech conversion process from one or more text character strings included in said script file.

8. A telephone system as set forth in claim 5 wherein at least some of said audible sounds delivered to said human operator are produced by voice signals produced by a human speaker at said remote location during a telephone conversation with said human operator and transmitted via said telephone connection from said remote location.

9. A telephone system as set forth in claim 1 wherein said one or more processors is programmed to perform a text to speech conversion process and wherein at least some of said audible sounds delivered to said human operator are produced by said text to speech conversion process from one or more text character strings included in said script file.

10. A telephone system as set forth in claim 1 wherein at least some of the visual information designated by said script file is produced by rendering one or more natural language text strings contained in said script file.

11. A telephone system as set forth in claim 1 wherein at least some of the visual information designated by said script file is produced by rendering the content of one or more separate media data objects which are external to but identified by said script file.

12. A telephone system as set forth in claim 11 wherein at least some of the visual information designated by said script file is produced by rendering one or more natural language text strings contained in said script file.

13. A telephone system as set forth in claim 1 wherein said script file comprises a file of text characters including imbedded markup tags that are recognized and interpreted by said one or more processors to identify and perform one or more of said plurality of functions.

14. A telephone system as set forth in claim 13 wherein at least part of said script file is expressed in HyperText Markup Language (HTML).

15. A telephone system as set forth in claim 13 wherein at least part of said script file is expressed in Extensible Markup Language (XML).

16. A telephone system as set forth in claim 13 wherein at least part of said script file is expressed in the Synchronized Multi-media Integration Language (SMIL).

17. A telephone system as set forth in claim 13 wherein at least part of said script file is expressed in the Voice Extensible Markup Language (VoiceXML).

18. A telephone system as set forth in claim 13 wherein said script file contains information describing said called person of entity at said remote location.
